(19) United States
(12) Patent Application Publication
(10) Pub. No.: US 2026/0093493 A1
(43) Pub. Date: Apr. 2, 2026

(54) OUT-OF-ORDER FETCH AND DECODE PIPELINES

(71) Applicant: Advanced Micro Devices, Inc., Santa Clara, CA (US)

(72) Inventors: Johnny C. Chu, Boxborough, MA (US); Scott Andrew McLelland, Boxborough, MA (US); Yueh-Chuan Tzeng, Boxborough, MA (US); Thomas Clouqueur, Boxborough, MA (US); Kai Troester, Boxborough, MA (US); Robert Cohen, Austin, TX (US); Frank C. Galloway, Austin, TX (US); Vanchinathan Venkataramani, Bangalore (IN); Aparna Chandrashekhar Mandke, Bangalore (IN)

(73) Assignee: Advanced Micro Devices, Inc., Santa Clara, CA (US)

(21) Appl. No.: 18/899,733

(22) Filed: Sep. 27, 2024

(51) Int. Cl. G06F 9/38; G06F 9/30

(52) U.S. Cl. CPC G06F 9/3802; G06F 9/3016; G06F 9/3808; G06F 9/3814; G06F 9/3818; G06F 9/382; G06F 9/3822; G06F 9/3836

(57) ABSTRACT

The disclosed device supports multiple fetch/decode pipelines that can be assigned instructions in an out-of-order fashion. The fetch/decode pipelines can operate separately and have respective operation queues for providing operations to a dispatch unit in a reordered fashion. Various other methods, systems, and computer-readable media are also disclosed.

### BACKGROUND

Computer processing requirement increasingly demand improved processor performance. Scaling up processor components, such as increasing a size of structures, can provide performance benefits, but can also face limitations, such as increased complexity, diminishing returns, manufacturing limitations, etc. Other performance improvements can be achieved by addressing efficiency, such as addressing performance bottlenecks.

For instance, an instruction pipeline, in which a processor processes software program instructions into hardware-executable operations, can have various bottlenecks that can limit a number of instructions per cycle (IPC). One such bottleneck can occur at a fetch stage of the instruction pipeline, in which instructions are fetched from memory (or cache) and decoded into operations. Increasing a throughput of the fetch stage can present timing, power, and other challenges.

### BRIEF DESCRIPTION OF THE DRAWINGS

The accompanying drawings illustrate number of exemplary implementations and are a part of the specification. Together with the following description, these drawings demonstrate and explain various principles of the present disclosure.

FIG. 1 is a block diagram of an exemplary system for an out-of-order fetch/decode pipeline.

FIG. 2 is a flow diagram of an exemplary instruction pipeline.

FIG. 3 is a block diagram of an exemplary fetch/decode pipeline.

FIGS. 4A-B are block diagrams of exemplary out-of-order fetch/decode multi-pipeline architectures.

FIG. 5 is a flow diagram of an exemplary method for out-of-order fetch/decode pipelines.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to multiple out-ot-order fetch/decode pipelines. As will be explained in greater detail below, implementations of the present disclosure provide a control circuit that manages assignment of instructions for fetching/decoding amongst multiple fetch pipelines. Each fetch pipeline includes an operation queue that, in conjunction with a multiplexer, allows providing a dispatch unit with operations in program order. The systems and methods provided herein advantageously allow more efficient fetching/decoding, including parallel fetching/decoding, to improve IPC, power consumption, and processing performance.

Features from any of the implementations described herein can be used in combination with one another in accordance with the general principles described herein. These and other implementations, features, and advantages will be more fully understood upon reading the following detailed description in conjunction with the accompanying drawings and claims.

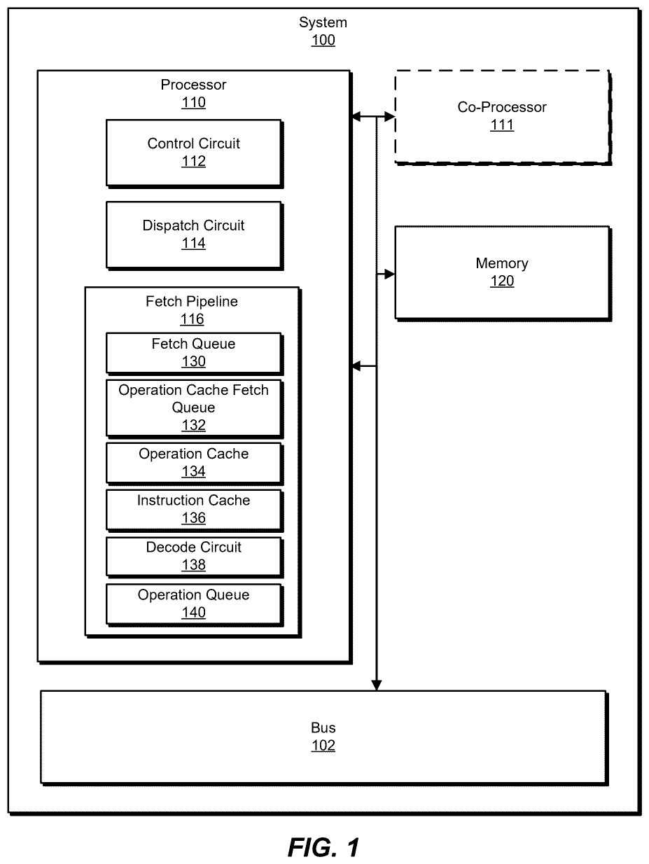

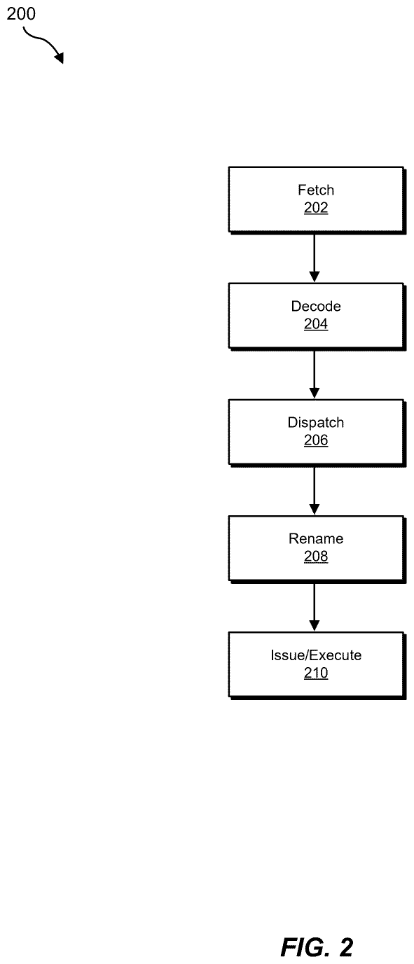

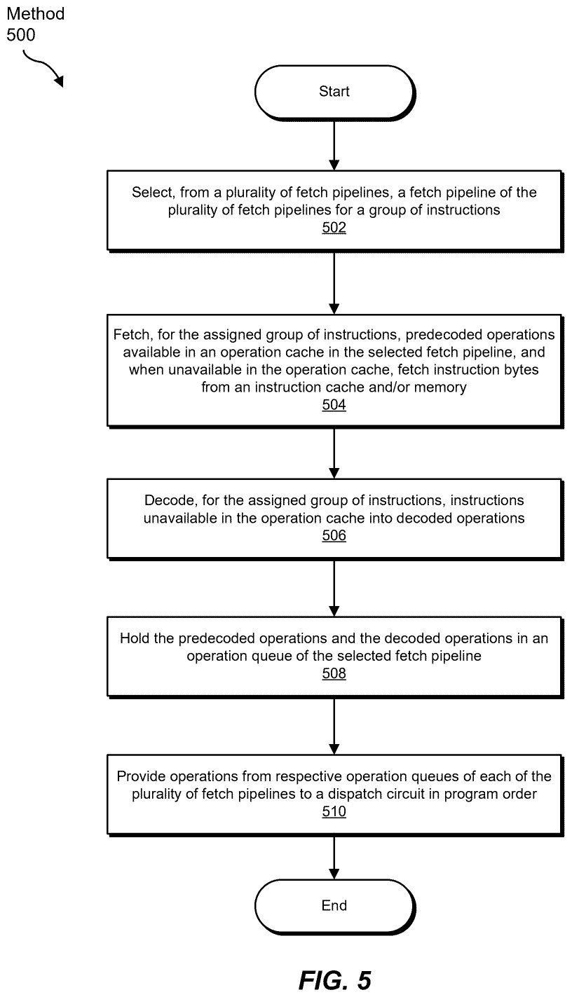

The following will provide, with reference to FIGS. 1-5, detailed descriptions of multiple fetch pipelines allowing parallel and out-of-order fetching and decoding. Detailed descriptions of example systems will be provided in connection with FIGS. 1, 3, and 4A-B. Detailed descriptions of an example instruction pipeline will be provided in connection with FIG. 2. Detailed descriptions of corresponding computer-implemented methods will also be provided in connection with FIG. 5.

FIG. 1 is a block diagram of an example system 100 for an out-of-order fetch and decode pipeline architecture. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110, which can correspond to one or more processors (e.g., a host processor along with a co-processor, which in some examples can be separate processors). Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, one or more instances of chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same (e.g., a host processor and a co-processor), and/or any other suitable physical processor(s). Further, in some examples, processor 110 can be a general-purpose processor that can be capable, without significant limitation, of various computing tasks, as opposed to a special purpose processor that can be limited in computing tasks (e.g., specially designed for particular computing tasks such as moving data, performing certain mathematical operations, etc.), although in other examples processor 110 can correspond to and/or incorporate one or more special purpose processors.

As also illustrated in FIG. 1, example system 100 can in some implementations optionally include one or more physical co-processors, such as co-processor 111, which in other implementations can be integrated with or otherwise represented by processor 110. Co-processor 111 generally represents any type or form of hardware-implemented processing unit capable of interpreting and/or executing computer-readable instructions, which in some examples works in conjunction and/or based on instructions from a host/main processor such as a CPU (e.g., processor 110). In some examples, co-processor 111 accesses and/or modifies data and/or instructions stored in memory 120. Examples of co-processor 111 include, without limitation, chiplets (e.g., smaller and in some examples more specialized processing units that can coordinate as a single chip), microprocessors, microcontrollers, graphics processing units (GPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same, and/or any other suitable physical processor.

FIG. 1 also includes a bus 102 that can correspond to any bus, circuitry, connections, and/or any other communicative pathways for sending communicative signals, based on one or more communication protocols, between components/devices (e.g., processor 110, memory 120, and/or co-processor 111, etc.). In some implementations, bus 102 can further connect, via wireless and/or wired connections, to other devices, such as peripheral devices external to or partially integrated with system 100. Although not illustrated in FIG. 1, in some implementations, system 100 can be coupled to a display device (e.g., via bus 102).

In some implementations, an instruction can correspond to computer code that can be read and executed by a processor. Examples of instructions include, without limitation, macro-instructions (e.g., program code that requires a processor to decode into processor instructions that the processor can directly execute) and micro-operations (e.g., low-level processor instructions that can be decoded from a macro-instruction and that form parts of the macro-instruction). In some implementations, micro-operations (uops) or operations can correspond to the most basic operations achievable by a processor and therefore can further be organized into micro-instructions (e.g., a set of micro-operations executed simultaneously).

As further illustrated in FIG. 1, processor 110 includes a control circuit 112, a dispatch circuit 114, and a fetch pipeline 116. Control circuit 112 corresponds to one or more circuits, circuitry and/or instructions for managing aspects of fetch and/or decode stages of an instruction pipeline, as will be described further below. Dispatch circuit 114 corresponds to one or more circuits, circuitry, and/or instructions for dispatching operations for execution by functional units of processor 110. Fetch pipeline 116 corresponds to one or more circuits, circuitry, and/or instructions for performing aspects of the fetch and/or decode stages, as will be described further below. Fetch pipeline 116 can provide operations to dispatch circuit 114. In some implementations, control circuit 112 can control fetch pipeline 116 and/or portions thereof. Additionally, in some examples, processor 110 can include multiple iterations of fetch pipeline 116.

FIG. 1 further illustrates fetch pipeline 116 including a fetch queue 130, an operation cache fetch queue 132, an operation cache 134, an instruction cache 136, a decode circuit 138, and an operation queue 140. Fetch queue 130 corresponds to a queue structure for queuing instructions to be fetched. Operation cache fetch queue 132 corresponds to a queue structure for queueing instructions to be fetched from operation cache 134, which corresponds to a cache structure for holding predecoded operations (e.g., instructions that have been previously decoded into operations). In some implementations, operation cache fetch queue 132 can be combined with fetch queue 130 (e.g., having fetch queue 130 for both a path to decode circuit 138 and a path to operation cache 134 rather than having a separate queue structure for operation cache 134). Instruction cache 136 corresponds to a cache structure for holding instructions to be decoded by a decode circuit 138, which corresponds to a circuit for decoding instructions into operations (e.g., decoding program/code instructions into micro-operations). Operation queue 140 corresponds to a queue structure for holding operations to be dispatched by dispatch circuit 114 as part of an instruction pipeline, although in some implementations, operation queue 140 can be optional (e.g., decoded instructions can be provided directly from decode circuit 138 and/or operation cache 134 without queueing). As will be described further below, in some examples, operation queue 140 can receive operations from operation cache 134 and/or decode circuit 138.

FIG. 2 illustrates an exemplary instruction pipeline 200 for a processor, such as processor 110, for executing instructions. During a fetch stage 202 (corresponding to fetch pipeline 116), processor 110 can read instructions from memory 120 (and/or a cache). Processor 110 can fetch instructions based on an active thread or threads, branch prediction, and/or other criteria. At decode stage 204 (corresponding to fetch pipeline 116), processor 110 can decode the read instructions into operations (e.g., uops) for dispatching at dispatch stage 206 (e.g., corresponding to dispatch circuit 114). At rename stage 208, processor 110 can allocate registers to the decoded operation as needed. After rename stage 208, processor 110 (and/or a functional unit thereof) can forward the renamed operations to a scheduler that can queue operations until they are ready for issue to execution units (e.g., at issue/execute stage 210). The scheduler can issue one or more operations that are ready for execution. In some examples, an operation can be ready for issue when its dependencies (e.g., resources that rely on other instructions to finish execution) have been resolved.

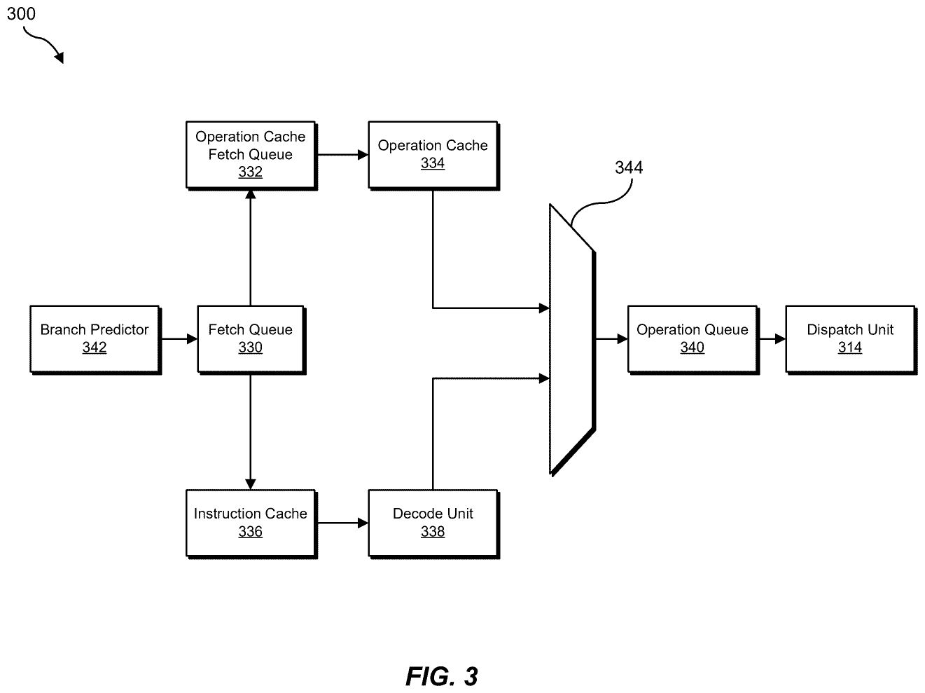

Focusing on the fetch and decode stages, FIG. 3 illustrates a pipeline 300 (corresponding to fetch pipeline 116). FIG. 3 includes a branch predictor 342, a fetch queue 330 (corresponding to fetch queue 130), an operation cache fetch queue 332 (corresponding to operation cache fetch queue 132), an operation cache 334 (corresponding to operation cache 134), an instruction cache 336 (corresponding to instruction cache 136), a decode unit 338 (corresponding to decode circuit 138), an operation queue 340 (corresponding to operation queue 140), a dispatch unit 314 (corresponding to dispatch circuit 114), and a multiplexer 344. Multiplexer 344 corresponds to a multiplexer circuit for selecting from multiple inputs to output.

Branch predictor 342 corresponds to circuitry and/or logic for predicting whether a branch instruction will be taken (e.g., such that a next instruction in a program branches or jumps to another location in the code) or not (e.g., such that the next instruction is the following instruction in the code). In some implementations, a processor (e.g., processor 110) can process/fetch multiple instructions in a given cycle. However, because branches can cause a program order of instructions to include non-contiguous groups of instructions, branch predictor 342 can coordinate which groups of instructions to be fetched for a given cycle. Accordingly, branch predictor 342 can, in some implementations, provide fetch queue 330 with instructions to be fetched.

In some examples, a controller (e.g., control circuit 112) can further coordinate pipeline 300. For instance, the controller can determine whether the instructions in fetch queue 330 are available in operation cache 334 (corresponding to a cache hit) such that the predecoded operations can be fetched rather than having to perform decoding. In such scenarios, the instructions can be queued in operation cache fetch queue 332, fetched from operation cache 334, and the operations provided to operation queue 340 via selection by multiplexer 344.

If the instructions in fetch queue 330 are not available in operation cache 334 (corresponding to an operation cache miss), the instructions can be queued in and/or fetched from instruction cache 336, decoded into operations by decode unit 338, and provided to operation queue 340 via selection by multiplexer 344. In some examples, based on appropriate selection by multiplexer 344, the operations can be provided to operation queue 340 in program order such that operation queue 340 can also provide the operations to dispatch unit 314 in program order.

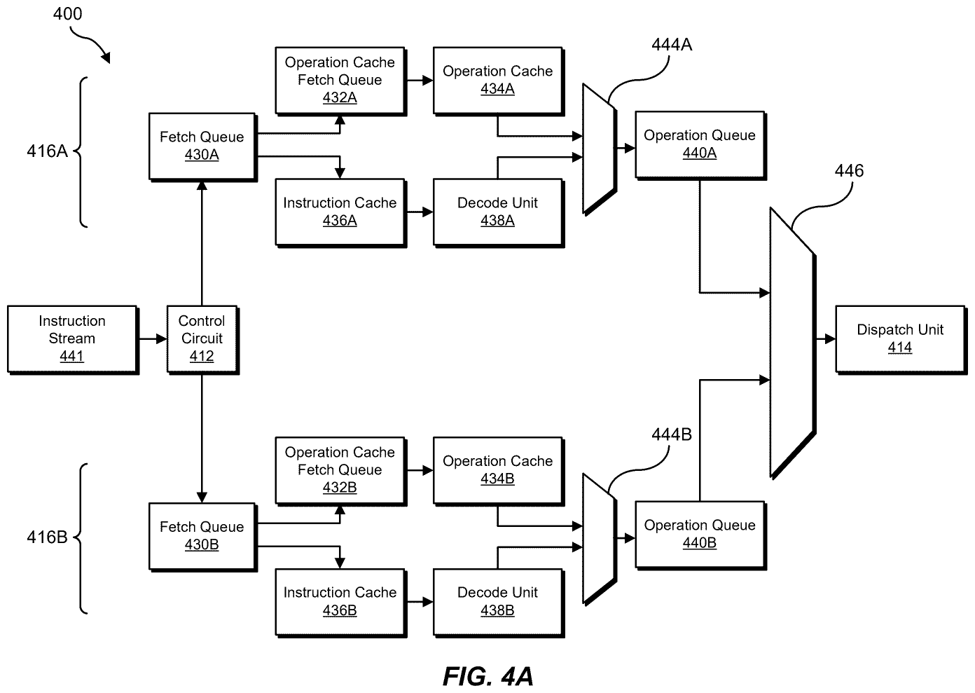

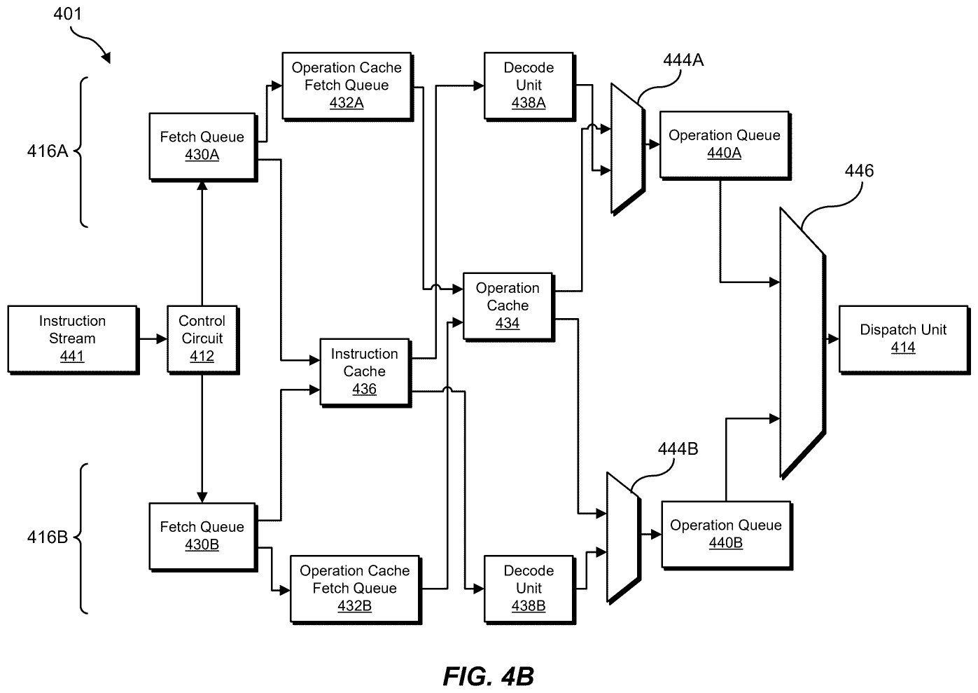

Certain aspects of pipeline 300, such as decoding instructions, can present bottlenecks. Although improving throughput for the decoding can alleviate such bottlenecks, maintaining operations in program order for the dispatch stage can present challenges. FIGS. 4A and 4B illustrate example architectures that allow multiple parallel fetch/decode pipelines that can be out of order.

FIG. 4A illustrates a pipeline 400 (corresponding to fetch pipeline 116). FIG. 4A includes an instruction stream 441 (corresponding to a source of instructions, such as branch predictor 342 or multiple threads), a control circuit 412 (corresponding to control circuit 112), a fetch queue 430A and a fetch queue 430B (each corresponding to iterations of fetch queue 130), an operation cache fetch queue 432A and an operation cache fetch queue 432B (each corresponding to iterations of operation cache fetch queue 132), an operation cache 434A and an operation cache 434B (each corresponding to iterations of operation cache 134), an instruction cache 436A and an instruction cache 436B (each corresponding to iterations of instruction cache 136), a decode unit 438A and a decode unit 438B (each corresponding to iterations of decode circuit 138), an operation queue 440A and an operation queue 440B (each corresponding to iterations of operation queue 140), a dispatch unit 414 (corresponding to dispatch circuit 114), a multiplexer 444A and a multiplexer 444B (each corresponding to iterations of multiplexer 344), and a multiplexer 446 (corresponding to a multiplexer circuit for selecting from multiple inputs to output).

FIG. 4A illustrates multiple parallel fetch/decode pipelines, namely a fetch pipeline 416A and a fetch pipeline 416B, each of which corresponding to iterations of fetch pipeline 116 and each operating generally independently similar to the fetch pipeline discussed above with respect to at least FIG. 3. Although FIG. 4A illustrates two fetch/decode pipelines, other examples can include additional fetch/decode pipelines. FIG. 4A further illustrates control circuit 412, which in some implementations can correspond to, be integrated with, or otherwise interface with the branch predictor and/or other form of instruction stream 441. Control circuit 412 can assign groups of instructions to fetch pipeline 416A or fetch pipeline 416B. Each fetch pipeline (e.g., fetch pipeline 416A and/or fetch pipeline 416B) can independently and/or in parallel process their respective groups of instructions. Each fetch pipeline can further provide decoded operations from operation queue 440A and/or operation queue 440B, respectively, to dispatch unit 414 via multiplexer 446.

Control circuit 412 can further assign the groups of instructions in an out-of-order fashion. Although in some implementations, within each group the instructions remain in order, control circuit 412 can assign the groups out of order with respect to the fetch pipelines, such as in a round-robin fashion in some examples, and/or employing a load balancing scheme in some examples. In some implementations, the groups of instructions can be of a fixed size (e.g., each group having a same number of instructions) although in other implementations, the groups of instructions can have different (e.g., dynamically determined) sizes. For example, control circuit 412 can use fetch boundaries provided by the branch predictor to determine instruction group boundaries for fetch pipeline assignment (e.g., maintaining groups of instructions as determined by the branch predictor such that in some examples the branch predictor can determine the groups of instructions). In some implementations, in the event of a branch misprediction, all fetch pipelines can be flushed of any younger fetches past the mispredicted branch.

In other examples, control circuit 412 can operate without the branch predictor, such as by assigning a first group of instructions for a first thread to fetch pipeline 416A, and a second group of instructions for a second thread to fetch pipeline 416B, allowing each fetch pipeline to process different threads as represented by instruction stream 441. In yet other examples, control circuit 412 can apply load balancing between fetch pipeline 416A and fetch pipeline 416B.

In some examples, such as when the fetch pipelines are assigned groups of instructions for a common thread, dispatch unit 414 receives the decoded operations in program order (e.g., the corresponding groups of instructions are in program order) via multiplexer 446 selecting between operation queue 440A and operation queue 440B (e.g., mirroring the order that control circuit 412 assigned the groups). Although in some implementations control circuit 412 can actively control multiplexer 446, in other implementations, control circuit 412 can send information and/or metadata (corresponding to a control signal for multiplexer 446) to allow multiplexer 446 to select accordingly. For instance, control circuit 412 can include a flag in a last instruction of a group of instructions that identifies the last instruction, which can propagate to multiplexer 446 and trigger a selection between inputs. When multiplexer 446 encounters this flag, multiplexer 446 can switch to another fetch pipeline for the next decoded operation, such as for implementations having two fetch pipelines (e.g., as illustrated in FIG. 4A) or pipelines assigned in a round-robin fashion, such that this flag can be a toggle signal for multiplexer 446 to switch to a next input. In other implementations, this flag can include a pointer to the fetch pipeline having the next operation in program order, such as when more than two fetch pipelines are used. For instance, this flag can correspond to a selection signal for switching multiplexer 446 directly to a specific input.

FIG. 4B illustrates a pipeline 401 corresponding to a variation of pipeline 400. In FIG. 4B, fetch pipeline 416A and fetch pipeline 416B can share an operation cache 434 (corresponding to operation cache 134) and/or an instruction cache 436 (corresponding to instruction cache 136). In some implementations, operation cache 434 can have input ports reserved for each of the fetch pipelines and output ports reserved for each of the fetch pipelines. Similarly, instruction cache 436 can have input ports reserved for each of the fetch pipelines and output ports reserved for each of the fetch pipelines. Accordingly, each of fetch pipeline 416A and fetch pipeline 416B can operate independently and in parallel while sharing certain structures. In yet other implementations, the fetch pipelines can further share structures in any combination that allows independent and parallel operation.

FIG. 5 is a flow diagram of an exemplary computer-implemented method 500 for an out-of-order fetch and decode pipelines. The steps shown in FIG. 5 can be performed by any suitable circuit, device, and/or computing system, including the system(s) illustrated in FIGS. 1 and/or 4A-4B. In one example, each of the steps shown in FIG. 5 represent an algorithm whose structure includes and/or is represented by multiple sub-steps, examples of which will be provided in greater detail below.

As illustrated in FIG. 5, at step 502 one or more of the systems described herein select, from a plurality of fetch pipelines, a fetch pipeline of the plurality of fetch pipelines for assigning a group of instructions. For example, control circuit 112 can select fetch pipeline 116.

The systems described herein can perform step 502 in a variety of ways. In one example, control circuit 412 can select between fetch pipeline 416A and fetch pipeline 416B. As described above, control circuit 412 can select a fetch pipeline based on information from instruction stream 441 (e.g., utilizing existing fetch boundaries to define instruction group boundaries for fetch pipeline assignment). In other examples, control circuit 412 can select based on maintaining certain instructions with certain fetch pipelines (e.g., keeping instructions for different threads isolated into different fetch pipelines).

At step 504 one or more of the systems described herein fetch, for the assigned group of instructions, predecoded operations available in an operation cache in the selected fetch pipeline. For example, fetch pipeline 116, and components thereof, can fetch the predecoded operations available in operation cache 134. For instructions unavailable in operation cache 134 (e.g., an operation cache miss), the systems described herein can fetch the instruction bytes from either instruction cache 136 and/or memory 120.

The systems described herein can perform step 504 in a variety of ways. In one example, operations available in operation cache 434A can be fetched, as propagated from fetch queue 430A and operation cache fetch queue 432A (e.g., corresponding to an operation cache hit path).

At step 506 one or more of the systems described herein decode, for the assigned group of instructions, instructions unavailable in the operation cache into decoded operations. For example, fetch pipeline 116, and more specifically decode circuit 138, can decode instructions not available in operation cache 134 after fetching from instruction cache 136 and/or memory (e.g., memory 120).

The systems described herein can perform step 506 in a variety of ways. In one example, instructions can propagate from fetch queue 430A to instruction cache 436A, and decoded by decode unit 438A (e.g., corresponding to an operation cache miss path).

At step 508 one or more of the systems described herein hold the predecoded operations and the decoded operations in an operation queue of the selected fetch pipeline. For example, operation queue 140 can hold the predecoded operations (e.g., from operation cache 134) and the decoded operations (e.g., from decode circuit 138) in program order.

The systems described herein can perform step 508 in a variety of ways. In one example, multiplexer 444A can select between operation cache 434A and decode unit 438A, based on program order, to provide operations to operation queue 440A.

At step 510 one or more of the systems described herein provide operations from respective operation queues of each of the plurality of fetch pipelines to a dispatch circuit in program order. For example, operation queue 140 can provide operations to dispatch circuit 114 in program order.

The systems described herein can perform step 510 in a variety of ways. In one example, multiplexer 446 can select between operation queue 440A and operation queue 440B based on program order. In some implementations, a last operation of a group of decoded operations includes a pointer to a fetch pipeline of the plurality of fetch pipelines that include a next decoded operation in the program order, thereby allowing multiplexer 446 to appropriately switch to the operation queue having the next decoded operation in program order.

In one implementation, a device for out-of-order fetch and decode includes a plurality of fetch pipelines each configured to fetch and decode instructions, a control circuit configured to assign groups of instructions to the plurality of fetch pipelines independent from program order, and a dispatch circuit configured to receive groups of decoded operations from the plurality of fetch pipelines corresponding to the assigned groups of instructions.

In some examples, each of the plurality of fetch pipelines includes a fetch queue configured to store an assigned group of instructions. In some examples, each of the plurality of fetch pipelines includes an operation cache configured to store predecoded operations. In some examples, each of the plurality of fetch pipelines includes an operation cache fetch queue configured to store instructions to be fetched from the operation cache. In some examples, at least two of the plurality of fetch pipelines share a common operation cache.

In some examples, each of the plurality of fetch pipelines includes a decode circuit configured to decode instructions not found in the operation cache. In some examples, each of the plurality of fetch pipelines includes an instruction cache configured to store instructions to be decoded by the decode circuit. In some examples, at least two of the plurality of fetch pipelines share a common instruction cache.

In some examples, each of the plurality of fetch pipelines includes an operation queue configured to store decoded operations from the respective fetch pipeline. In some examples, the device further includes a multiplexer coupling each operation queue to the dispatch circuit.

In some examples, the dispatch circuit is further configured to receive the groups of decoded operations in the program order. In some examples, a last operation of a group of decoded operations includes a pointer to a fetch pipeline of the plurality of fetch pipelines that include a next decoded operation in the program order. In some examples, the control circuit is further configured to assign the groups of instructions to the plurality of fetch pipelines based on a branch predictor circuit.

In one implementation, a system for out-of-order fetch and decode pipelines includes a memory, and a processor a plurality of fetch pipelines each configured to fetch and decode instructions. In some examples, each of the plurality of fetch pipelines include a fetch queue configured to store an assigned group of instructions, an operation cache configured to store predecoded operations, an operation cache fetch queue configured to store instructions to be fetched from the operation cache, a decode circuit configured to decode instructions not found in the operation cache, an instruction cache configured to store instructions to be decoded by the decode circuit, and an operation queue configured to store decoded operations from the respective fetch pipeline. In some examples, the processor also includes a control circuit configured to assign groups of instructions to the plurality of fetch pipelines independent from program order, a dispatch circuit configured to receive groups of decoded operations from the plurality of fetch pipelines corresponding to the assigned groups of instructions, and a multiplexer coupling each operation queue to the dispatch circuit.

In some examples, at least two of the plurality of fetch pipelines share a common operation cache. In some examples, at least two of the plurality of fetch pipelines share a common instruction cache.

In some examples, the dispatch circuit is further configured to receive the groups of decoded operations in the program order. In some examples, a last operation of a group of decoded operations includes a pointer to a fetch pipeline of the plurality of fetch pipelines that include a next decoded operation in the program order.

In some examples, the control circuit is further configured to assign the groups of instructions to the plurality of fetch pipelines based on a branch predictor circuit.

In one implementation, a method for out-of-order fetch and decode pipelines includes (i) selecting, from a plurality of fetch pipelines, a fetch pipeline of the plurality of fetch pipelines for assigning a group of instructions, (ii) fetching, for the assigned group of instructions, predecoded operations available in an operation cache in the selected fetch pipeline, (iii) decoding, for the assigned group of instructions, instructions unavailable in the operation cache into decoded operations, (iv) holding the predecoded operations and the decoded operations in an operation queue of the selected fetch pipeline, and (v) providing operations from respective operation queues of each of the plurality of fetch pipelines to a dispatch circuit in program order.

In some examples, a last operation of a group of decoded operations includes a pointer to a fetch pipeline of the plurality of fetch pipelines that include a next decoded operation in the program order.

As detailed above, in order to support up to two fetches per cycle, the fetch and decode pipelines of the processor can be duplicated and allowed to process fetches out-of-order between the two pipelines while fetches are still required to be processed in-order within each pipeline. The fetch/decode pipeline includes two pipelines or paths, one for instruction cache fetches and one for operation (op) cache fetches. At the dispatch (out-of-order execution resource allocation) stage, decoded operations from both pipelines are put back in-order before they enter the register rename stage.

Processing multiple fetches per cycle in a finer grained manner, can create a timing and power challenges. Having two pipes, each of which does one fetch per cycle as described herein, resolves those problems. Also, fetching from two different sections of the same instruction stream simultaneously and allowing writes to the two micro-op-queues (e.g., operation queues) to be out-of-order, can lead to more opportunity for actually processing fetches in parallel since the micro-op-queues can act as a buffer. In a multi-threaded mode, each pipe can be dedicated to a given thread's instruction stream, eliminating the issue of having to pick which thread to fetch and decode for in any given cycle, resulting in parallel fetch and decode for two threads at once.

The front end of the core has two independent fetch pipes. Each fetch pipe can support a mix of instruction cache fetches and op cache fetches. The fetches within a given pipe must be in program order, but the two pipes can be out-of-order relative to each other, as described above. If the next fetch in program order will be (or has been) sent on the other pipe, the current fetch can be marked as such (e.g., a FollowedByOtherPipe flag). In one implementation, a fetch marked FollowedByOtherPipe can be assumed to end with a predicted taken branch. In other implementations, fetch pipelines can be switched at non-branch points as long as the switch happens at an instruction boundary.

In the decode unit, each fetch pipe has a corresponding pipe to convert the fetches into ops. Each pipe, which consists of an instruction decoder to process OpCache misses and an OpCache read pipeline, writes ops into its own dedicated micro-op queue (UOQ, e.g., an operation queue as described above). In some implementations, there can be two UOQs, UOQ0 and UOQ1. Successive writes into a given UOQ must follow program order (e.g., each write must be further along in program order than the previous write, but each write is not necessarily consecutive from the previous write). However, writes to one UOQ may be out of program order relative to the other UOQ. There is no relationship between the writes to one UOQ and the writes to the other UOQ, when a pipe sees a fetch marked FollowedByOtherPipe, it can mark the last op of that fetch with a switch marker. In one implementation, the switch marker can always fall on a predicted taken branch, although in other implementations can fall on a different instruction boundary. This switch marker can be written along with the op into the UOQ. Although this example describes two fetch pipes, other examples can include multiple fetch pipes (e.g., more than two). In implementations having more than two fetch pipes, the switch marker on the last op can point to the UOQ that should be read next in order to preserve program order.

In some implementations, ops from the two UOQs need to be re-ordered back into program order when they are read out by the dispatch logic. In a two-fetch pipe example, the dispatch logic can start by reading UOQ0. When it encounters a switch marker, it switches to reading the other UOQ. Because the switch markers were generated from the fetch pipe indicating when the next fetch is on the other pipe, following switch markers allows the dispatch logic to combine the ops from the two UOQs such that it reads out ops in program order. In other implementations, the switch marker can identify which UOQ to switch to (e.g., when more than two UOQs are used).

In a single thread example, a branch predictor can split its predicted instruction stream into two pieces, one per pipe, which can be fetched independently from each other. In some implementations, the branch predictor can switch from one pipe to the other after on the first taken branch after X predictions, where X can be a configurable number. In some examples, a dynamic pipe assignment scheme for fetches can balances the occupancy of the UOQs (e.g., by modifying X based on performance metrics). The branch predictor can determine fetch pipe assignment. From the fetch pipe assignment, when the next fetch will be (or has been) sent on the other pipe can be determined in order to mark fetches as FollowedByOtherPipe.

In a multiple thread example, multiple independent instruction streams correspond to the multiple threads. The branch predictor can dedicate a fetch pipe to each instruction stream. In some implementations, such as if multiple fetch pipes are handling multiple threads, it is not necessary to order ops from the two UOQs in one single program order, because there is no one single program order.

Therefore, some implementations (e.g., where the multiple pipes are solely used for multithreading) do not include marking fetches with FollowedByOtherPipe or marking ops with a switch marker. In such implementations, UOQ the decode block reads can be dependent on picking which thread to dispatch ops for. Accordingly, each thread can have dedicated hardware for fetching instructions and writing ops into the UOQ, allowing for multiple threads at once. In other multithreaded implementations, each fetch pipe can be capable of supporting multiple threads. This increased complexity can provide the benefit of increased fetch bandwidth when some threads are currently idle and do not use their share of the combined fetch pipeline bandwidth.

With this design the complexities of having more than one fetch per cycle can advantageously be limited to picking the pipe which should handle the fetch and decode and combining ops from both pipelines into an in-order stream for the rename stage. In addition, this design can provide better performance in single thread examples because the op cache fetches can also arrive out of order. This design further provides better performance in multi-thread examples because each thread can have its own dedicated hardware, allowing all threads to be fetched from simultaneously.

In some aspects, the techniques described herein relate to a device including: a plurality of fetch pipelines each configured to fetch instructions; a control circuit configured to assign groups of instructions to the plurality of fetch pipelines independent from program order; and a dispatch circuit configured to receive groups of decoded operations, corresponding to the assigned groups of instructions, from the plurality of fetch pipelines via a multiplexer, coupled to each of the plurality of fetch pipelines, in program order.

In some aspects, the techniques described herein relate to a device, wherein the control circuit is further configured to provide a control signal to the multiplexer for selecting between the plurality of fetch pipelines to output to the dispatch circuit.

In some aspects, the techniques described herein relate to a device, wherein the control signal is triggered based on outputting a last operation of at least one of the groups of decoded operations to the dispatch circuit.

In some aspects, the techniques described herein relate to a device, wherein the last operation includes a pointer to a next fetch pipeline of the plurality of fetch pipelines, the next fetch pipeline includes a next decoded operation after the last operation in the program order, and the control signal corresponds to a selection signal for the multiplexer to switch to the next fetch pipeline.

In some aspects, the techniques described herein relate to a device, wherein the control signal corresponds to toggling between two of the plurality of fetch pipelines when the last operation is encountered.

In some aspects, the techniques described herein relate to a device, wherein the control signal corresponds to selecting the pointer to the next fetch pipeline based on a round-robin scheme.

In some aspects, the techniques described herein relate to a device, wherein the last operation corresponds to a last operation of a first thread before switching to a second thread.

In some aspects, the techniques described herein relate to a device, wherein at least one of the plurality of fetch pipelines includes: a fetch queue configured to store at least one of the assigned groups of instructions; an operation cache configured to store predecoded operations; an operation cache fetch queue configured to store instructions to be fetched from the operation cache; a decode circuit configured to decode instructions not found in the operation cache; and an instruction cache configured to store instructions to be decoded by the decode circuit.

In some aspects, the techniques described herein relate to a device, wherein at least two of the plurality of fetch pipelines share a common operation cache.

In some aspects, the techniques described herein relate to a device, wherein at least two of the plurality of fetch pipelines share a common instruction cache.

In some aspects, the techniques described herein relate to a device, wherein at least one of the plurality of fetch pipelines includes an operation queue configured to store decoded operations from the respective fetch pipeline, and the multiplexer is coupled between the operation queue and the dispatch circuit.

In some aspects, the techniques described herein relate to a device, wherein the control circuit is further configured to assign the groups of instructions to the plurality of fetch pipelines based on a branch predictor circuit.

In some aspects, the techniques described herein relate to a system including: a memory; and a processor including: a plurality of fetch pipelines each configured to fetch instructions, at least one of the plurality of fetch pipelines including: a fetch queue configured to store an assigned group of instructions; an operation cache configured to store predecoded operations; a decode circuit configured to decode instructions not found in the operation cache; and an instruction cache configured to store instructions to be decoded by the decode circuit; a control circuit configured to assign groups of instructions to the plurality of fetch pipelines independent from program order; a dispatch circuit configured to receive groups of decoded operations, corresponding to the assigned groups of instructions, from the plurality of fetch pipelines via a multiplexer, coupled to each of the plurality of fetch pipelines, in program order; and wherein the multiplexer couples each of the plurality of fetch pipelines to the dispatch circuit and is configured to receive a control signal from the control circuit for selecting between the plurality of fetch pipelines based on the program order.

In some aspects, the techniques described herein relate to a system, wherein the control signal is triggered based on outputting a last operation of at least one of the groups of decoded operations to the dispatch circuit.

In some aspects, the techniques described herein relate to a system, wherein the last operation includes a pointer to a next fetch pipeline of the plurality of fetch pipelines, the next fetch pipeline includes a next decoded operation after the last operation in the program order, and the control signal corresponds to a selection signal for the multiplexer to switch to the next fetch pipeline.

In some aspects, the techniques described herein relate to a system, wherein the last operation corresponds to a last operation of a first thread before switching to a second thread.

In some aspects, the techniques described herein relate to a system, wherein at least two of the plurality of fetch pipelines share at least one of a common operation cache or a common instruction cache.

In some aspects, the techniques described herein relate to a system, wherein the control circuit is further configured to assign the groups of instructions to the plurality of fetch pipelines based on a branch predictor circuit.

In some aspects, the techniques described herein relate to a method including: selecting, from a plurality of fetch pipelines, a fetch pipeline of the plurality of fetch pipelines for assigning a group of instructions independently from a program order; fetching, for the assigned group of instructions, predecoded operations available in an operation cache in the selected fetch pipeline; decoding, for the assigned group of instructions upon an operation cache miss, instructions into decoded operations; holding the predecoded operations and the decoded operations in an operation queue of the selected fetch pipeline; selecting, using a multiplexer coupled to the operation queues of the plurality of fetch pipelines, based on the program order; and providing, via the multiplexer, operations from respective operation queues of each of the plurality of fetch pipelines to a dispatch circuit in the program order.

In some aspects, the techniques described herein relate to a method, wherein a last operation of a group of decoded operations triggers a selection, by the multiplexer, of a next fetch pipeline of the plurality of fetch pipelines that include a next decoded operation in the program order.

As detailed above, the computing devices and systems described and/or illustrated herein broadly represent any type or form of computing device or system capable of executing computer-readable instructions, such as those contained within the code/firmware/programs described herein. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the instructions and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more instructions stored in the above-described memory device. Examples of physical processors include, without limitation, chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same (e.g., a host processor and a co-processor), and/or any other suitable physical processor.

In some examples, the term “physical processor” also refers to and/or includes a co-processor that generally refers to any type or form of hardware-implemented processing unit capable of interpreting and/or executing computer-readable instructions, which in some examples works in conjunction with and/or based on instructions from a host/main processor such as a CPU, and further in some examples accesses and/or modifies one or more instructions stored in the above-described memory device. Examples of co-processors include, without limitation, chiplets, microprocessors, microcontrollers, graphics processing units (GPUs), FPGAs that implement softcore processors, ASICs, SoCs, DSPs, NNEs, accelerators, portions of one or more of the same, variations or combinations of one or more of the same, and/or any other suitable physical processor.

Although described as separate elements/steps, the instructions described and/or illustrated herein can represent portions of a single program or application, including instructions implemented in code, firmware, one or more circuits, etc. In addition, in certain implementations one or more of these instructions can represent one or more software applications or programs that, when executed by a computing device, cause the computing device to perform one or more tasks. For example, one or more of the instructions described and/or illustrated herein represent instructions stored and configured to run on one or more of the computing devices or systems described and/or illustrated herein. In some implementations, one or more instructions can be implemented as a circuit or circuitry, including as part of a firmware, a ROM, one or more logic units, etc. One or more of these instructions can also represent or otherwise be implemented with all or portions of one or more special-purpose computers configured to perform one or more tasks.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A device comprising:
a plurality of fetch pipelines each configured to fetch instructions, wherein at least two of the plurality of fetch pipelines share a common operation cache;
a control circuit configured to assign groups of instructions to the plurality of fetch pipelines independent from program order; and
a dispatch circuit configured to receive groups of decoded operations, corresponding to the assigned groups of instructions, from the plurality of fetch pipelines via a multiplexer, coupled to each of the plurality of fetch pipelines, in program order.

2. The device of claim 1, wherein the control circuit is further configured to provide a control signal to the multiplexer for selecting between the plurality of fetch pipelines to output to the dispatch circuit.

3. The device of claim 2, wherein the control signal is triggered based on outputting a last operation of at least one of the groups of decoded operations to the dispatch circuit.

4. The device of claim 3, wherein the last operation includes a pointer to a next fetch pipeline of the plurality of fetch pipelines, the next fetch pipeline includes a next decoded operation after the last operation in the program order, and the control signal corresponds to a selection signal for the multiplexer to switch to the next fetch pipeline.

5. The device of claim 4, wherein the control signal corresponds to toggling between two of the plurality of fetch pipelines when the last operation is encountered.

6. The device of claim 4, wherein the control signal corresponds to selecting the pointer to the next fetch pipeline based on a round-robin scheme.

7. The device of claim 4, wherein the last operation corresponds to a last operation of a first thread before switching to a second thread.

8. The device of claim 1, wherein at least one of the plurality of fetch pipelines includes:
a fetch queue configured to store at least one of the assigned groups of instructions;
the common operation cache configured to store predecoded operations;
an operation cache fetch queue configured to store instructions to be fetched from the operation cache;
a decode circuit configured to decode instructions not found in the operation cache; and
an instruction cache configured to store instructions to be decoded by the decode circuit.

9. (canceled)

10. The device of claim 8, wherein at least two of the plurality of fetch pipelines share a common instruction cache.

11. The device of claim 1, wherein at least one of the plurality of fetch pipelines includes an operation queue configured to store decoded operations from the respective fetch pipeline, and the multiplexer is coupled between the operation queue and the dispatch circuit.

12. The device of claim 1, wherein the control circuit is further configured to assign the groups of instructions to the plurality of fetch pipelines based on a branch predictor circuit.

13. A system comprising:
a memory; and
a processor comprising:
a plurality of fetch pipelines each configured to fetch instructions, at least one of the plurality of fetch pipelines comprising:
a fetch queue configured to store an assigned group of instructions;
a common operation cache configured to store predecoded operations;
a decode circuit configured to decode instructions not found in the operation cache; and
an instruction cache configured to store instructions to be decoded by the decode circuit;
a control circuit configured to assign the assigned groups of instructions to the plurality of fetch pipelines independent from program order; and
a dispatch circuit configured to receive groups of decoded operations, corresponding to the assigned groups of instructions, from the plurality of fetch pipelines via a multiplexer, coupled to each of the plurality of fetch pipelines, in program order;
wherein the multiplexer couples each of the plurality of fetch pipelines to the dispatch circuit and is configured to receive a control signal from the control circuit for selecting between the plurality of fetch pipelines based on the program order, and
wherein at least two of the plurality of fetch pipelines share the common operation cache.

14. The system of claim 13, wherein the control signal is triggered based on outputting a last operation of at least one of the groups of decoded operations to the dispatch circuit.

15. The system of claim 14, wherein the last operation includes a pointer to a next fetch pipeline of the plurality of fetch pipelines, the next fetch pipeline includes a next decoded operation after the last operation in the program order, and the control signal corresponds to a selection signal for the multiplexer to switch to the next fetch pipeline.

16. The system of claim 14, wherein the last operation corresponds to a last operation of a first thread before switching to a second thread.

17. The system of claim 13, wherein at least two of the plurality of fetch pipelines share common instruction cache.

18. The system of claim 13, wherein the control circuit is further configured to assign the assigned groups of instructions to the plurality of fetch pipelines based on a branch predictor circuit.

19. A method comprising:
selecting, from a plurality of fetch pipelines, a fetch pipeline of the plurality of fetch pipelines for assigning a group of instructions independently from a program order;
fetching, for the assigned group of instructions, predecoded operations available in an common operation cache in the selected fetch pipeline, wherein at least two of the plurality of fetch pipelines share the common operation cache;
decoding, for the assigned group of instructions upon an operation cache miss, instructions into decoded operations;
holding the predecoded operations and the decoded operations in an operation queue of the selected fetch pipeline;
selecting, using a multiplexer coupled to operation queues of the plurality of fetch pipelines, based on the program order; and
providing, via the multiplexer, operations from the respective operation queues of each of the plurality of fetch pipelines to a dispatch circuit in the program order.

20. The method of claim 19, wherein a last operation of a group of decoded operations triggers a selection, by the multiplexer, of a next fetch pipeline of the plurality of fetch pipelines that includes a next decoded operation in the program order.

21. The device of claim 8, wherein the common operation cache includes input ports reserved for each of the at least two of the plurality of fetch pipelines.
